(19) United States
(12) Patent Application Publication
(10) Pub. No.: US 2026/0148619 A1
(43) Pub. Date: May 28, 2026

(54) CLAW ADJUSTMENT DEVICE FOR CRANE MACHINE

(71) Applicant: PAOKAI ELECTRONIC ENTERPRISE CO., LTD., Kaohsiung City (TW)

(72) Inventors: Ming-Shan WEI, Kaohsiung City (TW); Tung-Ying WEI, Kaohsiung City (TW)

(21) Appl. No.: 19/063,400

(22) Filed: Feb. 26, 2025

(30) Foreign Application Priority Data
Nov. 28, 2024 (TW) 113146098

(51) Int. Cl. G07F 17/32; A63F 9/30

(52) U.S. Cl. CPC G07F 17/3297; G07F 17/3216; A63F 9/30

(57) ABSTRACT

A claw adjustment device includes a support seat and an adjustment plate. The support seat has a core seat portion having positioning holes, and pivot seat portions each having an open recess. The adjustment plate has a core plate portion disposed on the core seat portion, and a positioning member that is connected to the core plate portion and that is engageable with one of the positioning holes. The adjustment plate is rotatable relative to the support seat from a first position, where the positioning member is engaged with one of the positioning holes and where the adjustment plate blocks a first proportion of each of the open recesses, to a second position, where the positioning member is engaged with another one of the positioning holes, and where the adjustment plate blocks a second proportion of each of the open recesses.

### CROSS-REFERENCE TO RELATED APPLICATION

This application claims priority to Taiwanese Invention Patent Application No. 113146098, filed on Nov. 28, 2024, the entire disclosure of which is incorporated by reference herein.

### FIELD

The disclosure relates to an adjustment device, and more particularly to a claw adjustment device for a crane machine.

### BACKGROUND

Referring to FIG. 1, an existing claw mechanism 1 of a crane machine (not shown) includes a driving member 11, a core rod 12 that is coaxially mounted to the driving member 11, a carrying seat 13 that is connected to a bottom end of the core rod 12, a plurality of claw bodies 14 that are equiangularly spaced apart from each other about the carrying seat 13 and that are pivotably connected to the carrying seat 13, and a plurality of linkage rods 15 each of which interconnects the driving member 11 and a respective one of the claw bodies 14. The core rod 12 is driven by the driving member 11 via internal coils to be telescopically moved relative to driving member 11, thereby driving the carrying seat 13 to move together therewith. When the carrying seat 13 is moved closest to the driving member 11, an end of each of the claw bodies 14 that is pivotably connected to the carrying seat 13 is moved closest to the driving member 11. As a result, each of the claw bodies 14 is rotated about a joint of the claw body 14 and the respective one of the linkage rods 15, so free ends of the claw bodies 14 opposite to the carrying seat 13 are moved toward each other. Accordingly, the claw bodies 14 are closed and cooperate with each other to grip an object. When the carrying seat 13 is moved away from the driving member 11, the free ends of the claw bodies 14 are moved away from each other, and the claw bodies 14 are open. However, in such a design of the existing claw mechanism 1, degrees of movements of the claw bodies 14 are limited by degrees of movements of the carrying seat 13 relative to the driving member 11. That is to say, the existing claw mechanism 1 is only suitable to grip a fixed-size prize. To grip differently sized prizes placed in the crane machine (not shown), the existing claw mechanism 1 may need to be replaced by another claw mechanism with degrees of opening and closing that are different from those of the existing claw mechanism 1 so as to be suitable for the prizes. Consequently, cost of purchasing additional claw mechanisms is increased for an owner, and frequent changes of the existing claw mechanisms may also be inconvenient for the owner.

Referring to FIG. 2, in view of the abovementioned drawback of the claw device 1, a claw mechanism 7 as disclosed in Taiwanese Utility Model Patent No. M653297 is adjustable to vary degrees of opening and closing thereof. The claw mechanism 7 includes a core rod 72, a spring 761, a carrying seat 73, an adjustment plate 762, and a plurality of claw bodies 74. The spring 761 is sleeved on the core rod 72. The adjustment plate 762 is sleeved on the core rod 72, and is located between the spring 761 and the carrying seat 73. The adjustment plate 762 is generally disc-shaped, and has a plurality of grooves 763 each of which is recessed from an outer circumferential periphery thereof in a radial direction. Lengths of the grooves 763 are different. The grooves 763 are grouped into a plurality of groove subsets that correspond in quantity to a quantity of the claw bodies 74. For each of the groove subsets, the lengths of the grooves 763 are different from each other. Each of the claw bodies 74 is allowed to be radially aligned and engaged with a corresponding one of the grooves 763 of a respective one of the groove subsets. Degrees of movement of each of the claw bodies 74 is limited by an end of a corresponding one of the grooves 763 adjacent to the core rod 72. The adjustment plate 762 is operable to rotate such that each of the claw bodies 74 and a corresponding one of the grooves 763 in different length of a respective one of the groove subsets are aligned and engaged with each other, thereby adjusting opening degrees of the claw bodies 74. However, although the spring 761 presses the adjustment plate 762 in an axial direction of the core rod 72 to restrict an upward movement of the adjustment plate 762, a rotation movement of the adjustment plate 762 is not restricted by the claw bodies 74 because the claw bodies 74, when in use, may be completely disengaged from the grooves 763, thereby making the adjustment plate 762 to be susceptible to an external force or vibrations, which causes the adjustment plate 762 to rotate and none of the grooves 763 of each of the groove subsets may be aligned and engaged with the respective one of the claw bodies 74. At this stage, the claw bodies 74 may be physically and structurally blocked by the adjustment plate 762 so the claw bodies 74 may be only opened to a minimum degree, or the adjustment plate 762 may be damaged by a larger operating force generated by the claw bodies 74. Furthermore, because the grooves 763 are recessed from the outer circumferential periphery of the adjustment plate 762, when taking structural strength of the adjustment plate 762 into consideration, the grooves 763 may not be arranged too close to each other. As a result, a quantity of the grooves 763 is limited, so adjustment to the opening degrees of the claw bodies 74 is limited.

FIG. 3 illustrates another claw mechanism 8 as disclosed in Taiwanese Invention Patent No. I809264. The claw mechanism 8 includes a core rod 82, a spring 871, a carrying seat 83, an adjustment plate 862, a plurality of claw bodies 84, and an insert rod 872. The adjustment plate 862 is a polygonal plate with a quantity of sides that corresponds to a quantity of the claw bodies 84. The adjustment plate 862 is formed with a plurality of through holes 864 that are angularly arranged relative to each other. The carrying seat 83 has a blind hole 831 in which the spring 871 and the insert rod 872 are disposed. When the insert rod 872 is aligned with a corresponding one of the through holes 864, the spring 871 resiliently biases and pushes the insert rod 872 upwardly into the corresponding through hole 864, thereby positioning the adjustment plate 862. By virtue of a particular geometric shape of the adjustment plate 862, when the adjustment plate 862 is rotated to a different position relative to the carrying seat 83, different portions of the adjustment plate 862 may restrict movements of the claw bodies 84, thereby adjusting opening degrees of the claw bodies 84. However, in such a design of the claw mechanism 8, in order to adjust opening degrees of the claw bodies 84 again, a needle tool needs to be used to press the insert rod 872 downwardly, thereby detaching the insert rod 872 from the corresponding through hole 864. Afterwards, the adjustment plate 862 is rotated again to adjust the opening degree of the claw bodies 84. The insert rod 872 is tiny, and is difficult to be aligned and pressed by the needle tool. Furthermore, the needle tool is necessary in rotating the adjustment plate 862. As a result, it is difficult and inconvenient to operate the claw mechanism 8.

### SUMMARY

Therefore, an object of the disclosure is to provide a claw adjustment device that can alleviate at least one of the drawbacks of the prior art.

According to the disclosure, the claw adjustment device is adapted to be mounted to a claw mechanism of a crane machine. The claw mechanism includes a driving member, a core rod that is telescopically mounted on the driving member, a plurality of linkage rods that are connected to the driving member and that are angularly spaced apart from each other, and a plurality of claw bodies. Each of the plurality of linkage rods has a first end that is connected pivotally to the driving member, and a second end that is opposite to the first end. Each of the plurality of claw bodies is connected pivotally to the second end of a respective one of the plurality of linkage rods. The claw adjustment device includes a support seat and an adjustment plate.

The support seat has a core seat portion and a plurality of pivot seat portions. The core seat portion is cylindrical, has a central axis adapted to be colinear with a longitudinal axis of the core rod, is adapted to be connected coaxially to the core rod, and has a plurality of positioning holes circumferentially spaced apart from each other and extending parallel to the central axis. The plurality of pivot seat portions extend outwardly from the core seat portion. Each of the plurality of pivot seat portions has an open recess that is recessed from a distal end of the pivot seat portion opposite to the core seat portion, extends therethrough in a direction parallel to the central axis, and is adapted to be pivotally engaged with a respective one of the claw bodies.

The adjustment plate is adapted to be connected between the support seat and the core rod, and has a core plate portion and a positioning member. The core plate portion is disposed on the core seat portion and has a though hole adapted to allow extension of the core rod therethrough. The positioning member is connected to the core plate portion, extends toward the support seat, and is engageable with one of the positioning holes.

The adjustment plate is rotatable about the central axis relative to the support seat from a first position, where the positioning member is engaged with one of the plurality of positioning holes and where the adjustment plate blocks a first proportion of each of the open recesses, to a second position, where the positioning member is engaged with another one of the plurality of positioning holes, and where the adjustment plate blocks a second proportion of each of the open recesses.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating an existing claw mechanism of a crane machine.

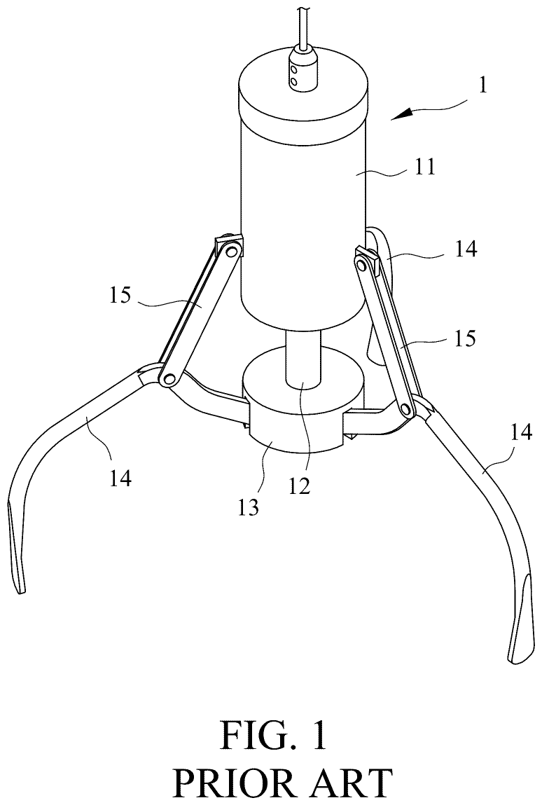

FIG. 2 is a perspective view illustrating a claw mechanism disclosed in Taiwanese Utility Model Patent No. M653297.

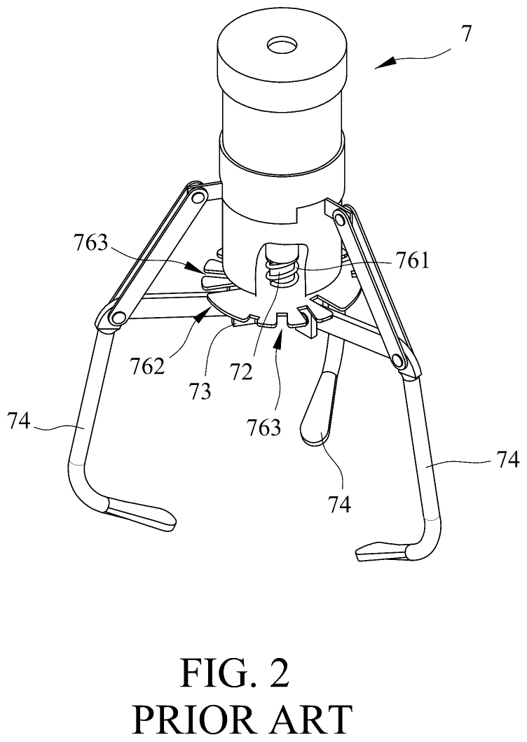

FIG. 3 is a partly perspective view illustrating a claw mechanism disclosed in Taiwanese Invention Patent No. I809264.

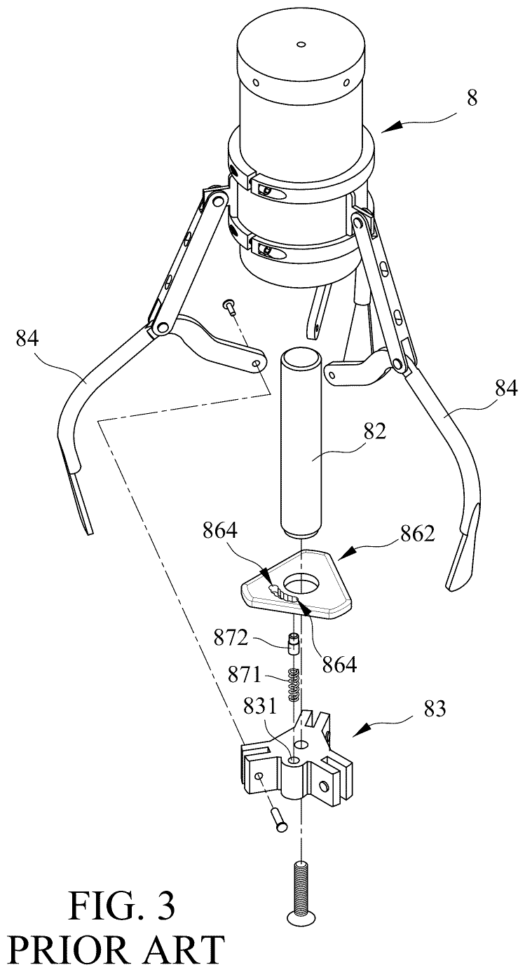

FIG. 4 is a perspective view illustrating a claw adjustment device according to an embodiment of the disclosure, the claw adjustment device being adapted to be mounted to a claw mechanism.

FIG. 5 is a partly perspective view illustrating the claw adjustment device of the embodiment and the claw mechanism.

FIG. 6 is an exploded perspective view illustrating the claw adjustment device of the embodiment.

FIG. 7 is a top view of the embodiment illustrating an adjustment plate of the claw adjustment device rotated to a first position relative to a support seat of the claw adjustment device.

FIG. 8 is a top view of the embodiment illustrating the adjustment plate rotated to a second position relative to a support seat.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

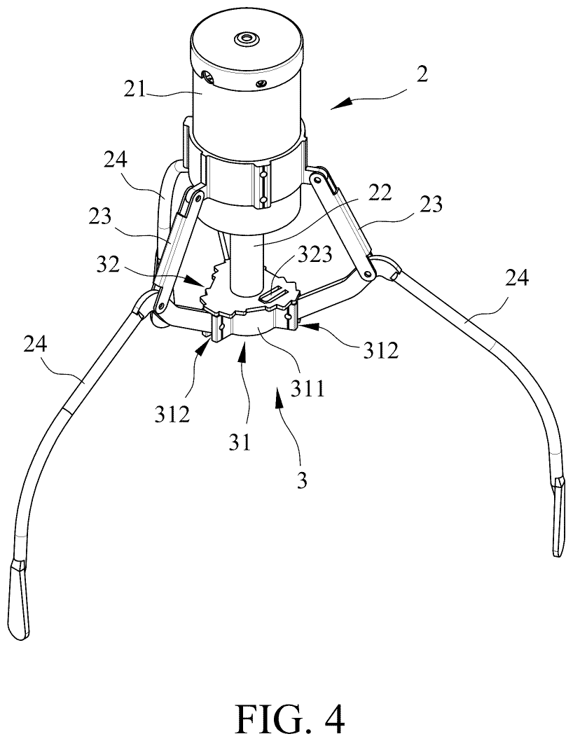

Referring to FIGS. 4 to 6, a claw adjustment device 3 according to an embodiment of the disclosure is adapted to be mounted to a claw mechanism 2 of a crane machine (not shown). The claw mechanism 2 includes a driving member 21, a core rod 22 that is telescopically mounted on the driving member 21, three linkage rods 23 that are connected to the driving member 21 and that are angularly spaced apart from each other, and three claw bodies 24. Each of the linkage rods 23 has a first end that is connected pivotally to the driving member 21, and a second end that is opposite to the first end. Each of the claw bodies 24 is connected pivotally to the second end of a respective one of the plurality of linkage rods 23. The claw adjustment device 3 includes a support seat 31 and an adjustment plate 32 that is adapted to be connected between the support seat 31 and the core rod 22.

The support seat 31 has a core seat portion 311 and three pivot seat portions 312. The core seat portion 311 is cylindrical, has a central axis adapted to be colinear with a longitudinal axis of the core rod 22, is adapted to be connected coaxially to the core rod 22, and has a plurality of positioning holes 314 circumferentially spaced apart from each other and extending parallel to the central axis. The pivot seat portions 312 extend outwardly from the core seat portion 311. Each of the pivot seat portions 312 has an open recess 313 that is recessed from a distal end of the pivot seat portion 312 opposite to the core seat portion 311, that extends therethrough in a direction parallel to the central axis, and that is adapted to be pivotally engaged with a respective one of the claw bodies 24.

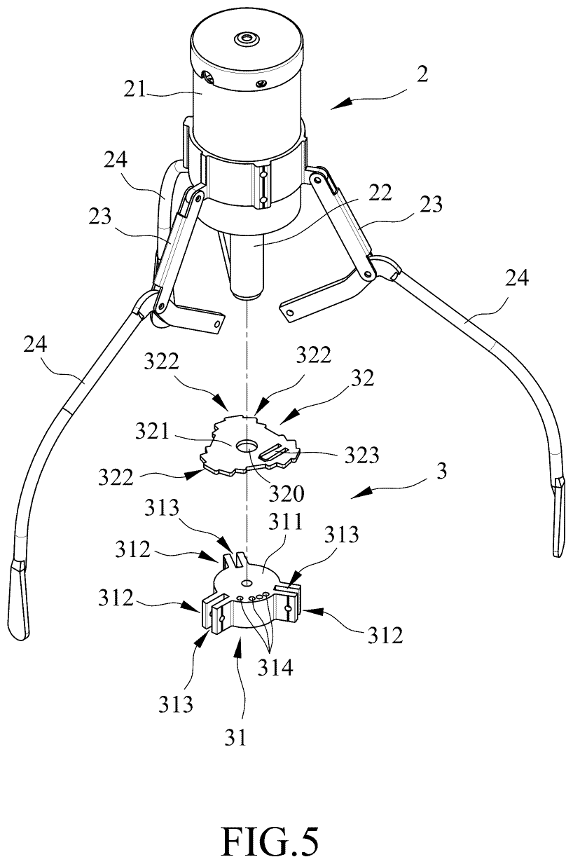

Referring to FIGS. 5, 6, and 7, the adjustment plate 32 is adapted to be connected between the support seat 31 and the core rod 22, and has a core plate portion 321 and a positioning member 324. The core plate portion 321 is disposed on the core seat portion 311 and has a though hole 320 adapted to allow extension of the core rod 22 therethrough. The positioning member 324 is connected to the core plate portion 321, extends toward the support seat 31, and is engageable with one of the positioning holes 314. In this embodiment, the adjustment plate 32 further has a plurality of protrusion subsets and a resilient plate portion 323, and the core plate portion 321 of the adjustment plate 32 further has a slot 325. Each of the protrusion subsets includes a plurality of protrusion portions 322 protruding outwardly from the core plate portion 321. In addition, the core plate portion 321 further has a plurality of outer peripheral surfaces 326. The resilient plate portion 323 is integrally connected to and extends from the core plate portion 321 into the slot 325. The positioning member 324 is substantially cylindrical, and protrudes from a distal end of the resilient plate portion 323 opposite to an end of the resilient plate portion 323 connected to the core plate portion 321. Furthermore, the adjustment plate 32 is deformable to generate a resilient restoring force. As a result, when a force is applied on the resilient plate portion 323 of the adjustment plate 32, the resilient plate portion 323 is forced to move in the direction parallel to the central axis. After the force is released from the resilient plate portion 323, the resilient plate portion 323 may be restored by the resilient restoring force.

Specifically, the adjustment plate 32 may be made from a metal material and formed by stamping. In this embodiment, a quantity of the protrusion portions 322 of the adjustment plate 32 is fifteen, and a quantity of the protrusion subsets is three. Each of the three protrusion subsets has five of the protrusion portions 322. Each of the outer peripheral surfaces 326 of the core plate portion 321 interconnects a respective adjacent pair of the protrusion subsets. Each of the protrusion portions 322 has an outermost surface 327 that is distal from the central axis. For each of the protrusion subsets, a minimum distance between the outermost surface 327 of each of the protrusion portions 322 and the central axis is different from a minimum distance between the outermost surface 327 of an adjacent one of the protrusion portions 322 and the central axis. A minimum distance between each of the outer peripheral surfaces 326 and the central axis is smaller than the minimum distance between the outermost surface 327 of each of the protrusion portions 322 and the central axis.

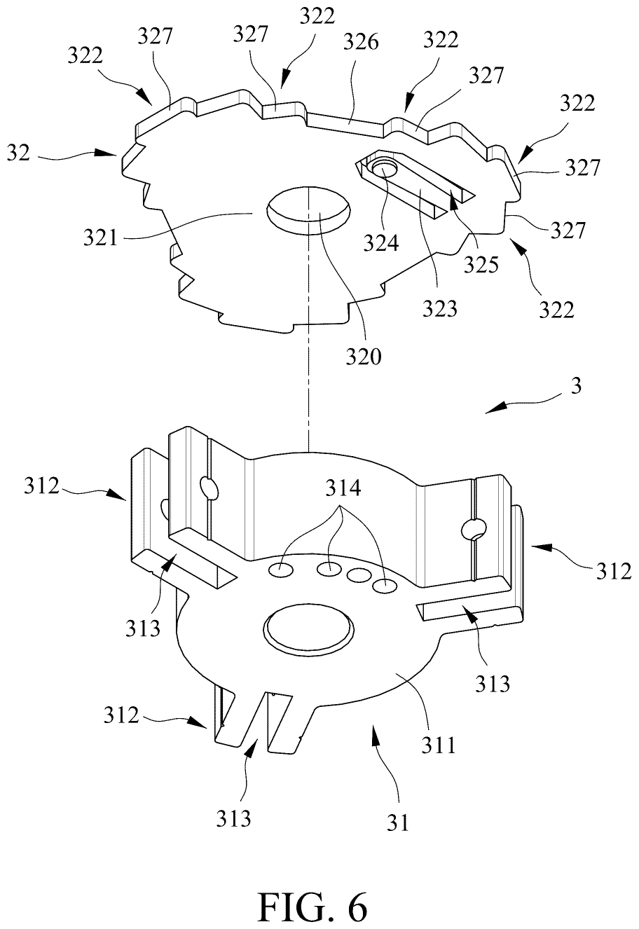

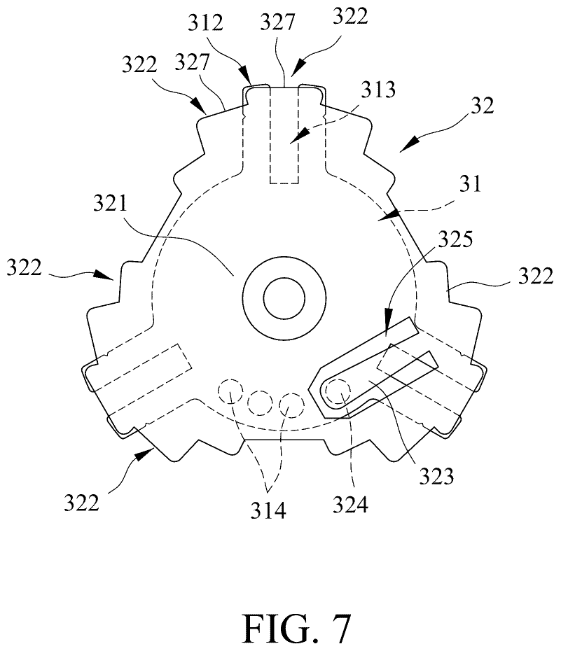

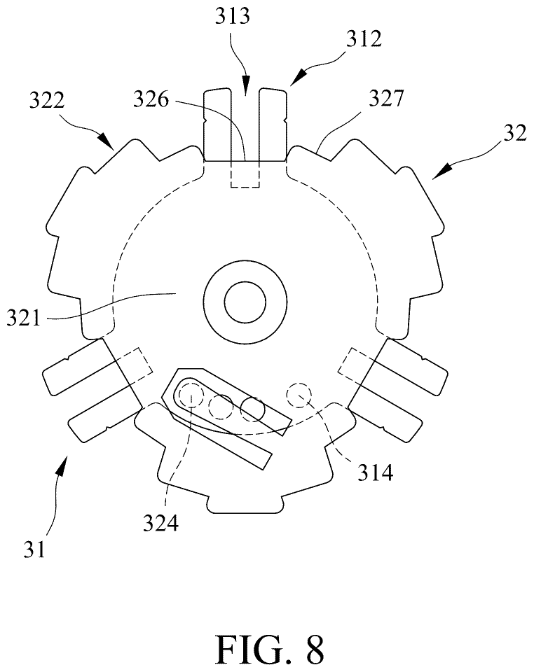

Referring to FIGS. 6, 7, and 8, the adjustment plate 32 is rotatable about the central axis relative to the support seat 31 from a first position, where the positioning member 324 is engaged with one of the positioning holes 314 and where the adjustment plate 32 blocks a first proportion of each of the open recesses 313, to a second position, where the positioning member 324 is engaged with another one of the positioning holes 314, and where the adjustment plate 32 blocks a second proportion of each of the open recesses 313. As shown in FIG. 7, when the adjustment plate 32 is in the first position, the protrusion subsets are respectively aligned with the pivot seat portions 312, and one of the protrusion portions 322 of each of the protrusion subsets blocks the first proportion of the open recess 313 of the respective one of the pivot seat portions 312 so as to limit movements of the respective claw body 24. Accordingly, the claw bodies 24 are adjusted to be less away from each other when the adjustment plate 32 is in the first position. As shown in FIG. 8, when the adjustment plate 32 is in the second position, the outer peripheral surfaces 326 are respectively aligned with the pivot seat portions 312, and the core plate portion 321 blocks the second proportion of the open recess 313 of each of the pivot seat portions 312. Because the minimum distance between each of the outer peripheral surfaces 326 and the central axis is smaller than the minimum distance between the outermost surface 327 of each of the protrusion portions 322 and the central axis, the claw bodies 24 are adjusted to be further away from each other when the adjustment plate 32 is in the second position. As the adjustment plate 32 is rotated relative to the support seat 31, the positioning member 324 is likely to be disengaged from one of the positioning holes 314 and engaged with the other one of the positioning holes 314. In this embodiment, when the adjustment plate 32 is in the first position, the resilient plate portion 323 is resiliently deformable to disengage the positioning member 324 from the one of the positioning holes 314, thereby allowing rotation of the adjustment plate 32 to the second position and urging the positioning member 324 to be engaged with the other one of the positioning holes 314 when the adjustment plate 32 is in the second position, and vice versa. Because, for each of the protrusion subsets, the minimum distance between the outermost surface 327 of each of the protrusion portions 322 and the central axis is different from the minimum distance between the outermost surface 327 of the adjacent one of the protrusion portions 322 and the central axis, when the open recess 313 of each of the pivot seat portions 312 is blocked by a respective one of the protrusion portions 322 different in the minimum distance from the central axis relative to each other, degrees of movement of the claw bodies 24 relative to each other are thereby adjusted and limited. When the open recess 313 of each of the pivot seat portions 312 is blocked by the core plate portion 321, the claw bodies 24 are adjusted to have the maximum degree of movement relative to each other.

It is worth mentioning that engagement of the positioning member 324 with one of the positioning holes 314 and resilient resistance of the resilient plate portion 323 prevent rotation and axial movement of the adjustment plate 32 relative to the support seat 31. Furthermore, no installation of an additional spring is required, thereby reducing a quantity of components. The quantity of the protrusion portions 322 of the adjustment plate 32 is not limited hereto, and may vary depending on requirements for adjusting degrees of movement of the claw bodies 24 relative to each other. In addition, there is no need of additional tools for operating of the claw adjustment device 3, so the claw adjustment device 3 is easy and convenient to adjust.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A claw adjustment device adapted to be mounted to a claw mechanism of a crane machine, the claw mechanism including a driving member, a core rod that is telescopically mounted on the driving member, a plurality of linkage rods that are connected to the driving member and that are angularly spaced apart from each other, and a plurality of claw bodies, each of the linkage rods having a first end that is connected pivotally to the driving member, and a second end that is opposite to the first end, each of the plurality of claw bodies being connected pivotally to the second end of a respective one of the plurality of linkage rods, said claw adjustment device comprising:
a support seat having
a core seat portion that is cylindrical, that has a central axis adapted to be colinear with a longitudinal axis of the core rod, that is adapted to be connected coaxially to the core rod, and that has a plurality of positioning holes circumferentially spaced apart from each other and extending parallel to the central axis, and
a plurality of pivot seat portions that extend outwardly from said core seat portion, each of said plurality of pivot seat portions having an open recess that is recessed from a distal end of said pivot seat portion opposite to said core seat portion, that extends therethrough in a direction parallel to the central axis, and that is adapted to be pivotally engaged with a respective one of the plurality of claw bodies; and
an adjustment plate adapted to be connected between said support seat and the core rod, and having
a core plate portion that is disposed on said core seat portion and that has a though hole adapted to allow extension of the core rod therethrough, and
a positioning member that is connected to said core plate portion, that extends toward said support seat, and that is engageable with one of said plurality of positioning holes;
wherein said adjustment plate is rotatable about the central axis relative to said support seat from a first position, where said positioning member is engaged with one of said plurality of positioning holes and where said adjustment plate blocks a first proportion of each of said open recesses, to a second position, where said positioning member is engaged with another one of said plurality of positioning holes, and where said adjustment plate blocks a second proportion of each of said open recesses.

2. The claw adjustment device as claimed in claim 1, wherein:
said adjustment plate further has a plurality of protrusion subsets, each of said plurality of protrusion subsets includes a plurality of protrusion portions protruding outwardly from said core plate portion, each of said plurality of protrusion portions has an outermost surface that is distal from the central axis;
for each of said plurality of protrusion subsets, a minimum distance between said outermost surface of each of said plurality of protrusion portions and the central axis is different from a minimum distance between said outermost surface of an adjacent one of said plurality of protrusion portions and the central axis;
said core plate portion further has a plurality of outer peripheral surfaces, each of said plurality of outer peripheral surfaces interconnecting a respective adjacent pair of said plurality of protrusion subsets;
when said adjustment plate is in the first position, said protrusion subsets are respectively aligned with said plurality of pivot seat portions, and one of said plurality of protrusion portions of each of said plurality of protrusion subsets blocks the first proportion of said open recess of the respective one of said plurality of pivot seat portions; and
when said adjustment plate is in the second position, said plurality of outer peripheral surfaces are respectively aligned with said plurality of pivot seat portions, and said core plate portion blocks the second proportion of said open recess of each of said plurality of pivot seat portions.

3. The claw adjustment device as claimed in claim 1, wherein:
said core plate portion of said adjustment plate further has a slot;
said adjustment plate further has a resilient plate portion that extends from said core plate portion into said slot;
said positioning member protrudes from a distal end of said resilient plate portion opposite to an end of said resilient plate portion connected to said core plate portion; and
when said adjustment plate is in the first position, said resilient plate portion is resiliently deformable to disengage said positioning member from said one of said plurality of positioning holes, thereby allowing rotation of said adjustment plate to the second position.

4. The claw adjustment device as claimed in claim 2, wherein:
a quantity of said plurality of pivot seat portions of said support seat is three;
a quantity of said plurality of protrusion portions of said adjustment plate is fifteen; and
a quantity of said plurality of outer peripheral surfaces of said core plate portion of said adjustment plate is three.
